(19) United States
(12) Patent Application Publication
(10) Pub. No.: US 2024/0393556 A1
(43) Pub. Date: Nov. 28, 2024

(54) MOUNT BRACKET FOR FIBER OPTIC CLOSURE

(71) Applicant: AFL Telecommunications LLC, Duncan, SC (US)

(72) Inventors: Eddie Kimbrell, Dacula, GA (US); David Wittmeier, Greer, SC (US); Tyler Clas, Wittmeier, SC (US)

(21) Appl. No.: 18/693,549

(22) PCT Filed: Sep. 15, 2022
(86) PCT No.: PCT/US2022/043619

§ 371 Date: Mar. 20, 2024

Related U.S. Application Data
(60) Provisional application No. 63/246,126, filed on Sep. 20, 2021.

(51) Int. Cl. G02B 6/44; G02B 6/50

(52) U.S. Cl. CPC G02B 6/4442; G02B 6/44785; G02B 6/501; G02B 6/504

(57) ABSTRACT

A mount structure for a fiber optic closure is provided. The mount structure includes a first bracket extending along a first axis. The first bracket includes a plurality of first bracket walls at least partially surrounding the first axis. A plate includes a plate wall extending along a second radial direction extending from a second axis. A plate opening extends along the second axis through the plate wall. An arm is extending from the first bracket to the plate. The arm includes a first arm portion extending along a first radial direction from the first axis and a second arm portion extending along the second radial direction.

### CROSS REFERENCE TO RELATED APPLICATIONS

The present application claims priority to U.S. Provisional Application Ser. No. 63/246,126, filed on Sep. 20, 2021 and which is incorporated by reference herein in its entirety.

### FIELD

The present disclosure relates generally to mount structures for fiber optic closures.

### BACKGROUND

In many metropolitan areas, fiber optic closures are kept underground, such as in handholes, so that the fiber optic closures cannot be seen or disrupted by members of the public. The fiber optic closures are secured in various ways in the handholes. In some instances, the fiber optic closure is placed on the ground within the handhole. In other instances, the fiber optic closure is attached to a pole, a rail, or other member within the handhole. Generally, the fiber optic closure is placed, attached, or secured within the handhole in a variety of ways or methods.

Furthermore, known methods and structures may fix the fiber optic closure within the handhole and inhibit articulation of the fiber optic closure within or out of the handhole. Known structures and methods may additionally inhibit placement of the fiber optic closure at a height or location that facilitates maintenance, assembly, disassembly, or operation at the fiber optic structure by a person.

Accordingly, there is a need for structures that allows for universal and standardized placement, attachment, and securing of the fiber optic closure in a handhole. Additionally, there is a need for structures that provide for articulation of the fiber optic closure within or out of a handhole. Still further, there is a need for structures that place a fiber optic closure at a height or location that facilitates operation at the fiber optic structure by a person.

### BRIEF DESCRIPTION

Aspects and advantages of the invention in accordance with the present disclosure will be set forth in part in the following description, or may be obvious from the description, or may be learned through practice of the technology.

A mount structure for a fiber optic closure is provided. The mount structure includes a first bracket extending along a first axis. The first bracket includes a plurality of first bracket walls at least partially surrounding the first axis. A plate includes a plate wall extending along a second radial direction extending from a second axis. A plate opening extends along the second axis through the plate wall. An arm is extending from the first bracket to the plate. The arm includes a first arm portion extending along a first radial direction from the first axis and a second arm portion extending along the second radial direction.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1A depicts a perspective view of an embodiment of a mount structure for a fiber optic closure in accordance with aspects of the present disclosure:

FIG. 1B depicts an exploded perspective view of an embodiment of the mount structure for a fiber optic closure in accordance with aspects of the present disclosure:

FIG. 2A depicts an exploded perspective view of an embodiment of the mount structure for a fiber optic closure in accordance with aspects of the present disclosure:

FIG. 2B depicts a partially assembled view of an embodiment of the mount structure for a fiber optic closure in accordance with aspects of the present disclosure;

FIG. 2C depicts a perspective view of an embodiment of the mount structure for a fiber optic closure in accordance with aspects of the present disclosure:

FIG. 2D depicts a perspective view of an embodiment of the mount structure for a fiber optic closure in accordance with aspects of the present disclosure:

FIG. 3A illustrates an exemplary operation of the mount structure in accordance with aspects of the present disclosure:

FIG. 3B illustrates an exemplary operation of the mount structure in accordance with aspects of the present disclosure:

FIG. 4A depicts an embodiment of an adjustable clamping bracket for embodiments of the mount structure in accordance with aspects of the present disclosure:

FIG. 4B depicts an embodiment of the adjustable clamping bracket for embodiments of the mount structure in accordance with aspects of the present disclosure:

FIG. 4C depicts an exploded perspective view of an embodiment of the adjustable clamping bracket for embodiments of the mount structure in accordance with aspects of the present disclosure:

FIG. 5 depicts a perspective view of an embodiment of the mount structure and fiber optic closure in accordance with aspects of the present disclosure:

FIG. 6 depicts a perspective view of an embodiment of a second bracket of an embodiment mount structure in accordance with aspects of the present disclosure:

FIG. 7 depicts a side view of an embodiment of a second bracket of an embodiment mount structure in accordance with aspects of the present disclosure:

FIG. 8 depicts a perspective view of an embodiment of a portion of the mount structure in accordance with aspects of the present disclosure:

FIG. 9 depicts a side view of an embodiment of a portion of the mount structure in accordance with aspects of the present disclosure;

FIG. 10 depicts a side view of an embodiment of a portion of the mount structure in accordance with aspects of the present disclosure:

FIG. 11 depicts an exploded perspective view of an embodiment of a portion of the mount structure in accordance with aspects of the present disclosure:

FIG. 12 depicts a side view of an embodiment of a portion of the mount structure in accordance with aspects of the present disclosure:

FIG. 13 depicts a side view of an embodiment of a portion of the mount structure in accordance with aspects of the present disclosure:

FIG. 14 depicts a side view of an embodiment of a portion of the mount structure in accordance with aspects of the present disclosure:

FIG. 15A depicts a perspective view of an embodiment of a portion of the mount structure in a first position in accordance with aspects of the present disclosure:

FIG. 15B depicts a perspective view of an embodiment of a portion of the mount structure in a second position in accordance with aspects of the present disclosure:

FIG. 16 depicts a perspective view of an embodiment of the mount structure for the fiber optic closure in accordance with aspects of the present disclosure:

FIG. 17A illustrates an exemplary operation of the mount structure in accordance with aspects of the present disclosure; and

FIG. 17B illustrates an exemplary operation of the mount structure in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Ranges provided herein are inclusive of their end points. For instance, a range of 1 to 100 includes 1 and 100.

Terms of approximation, such as “about,” “generally,” “approximately,” or “substantially,” include values within a ten percent full scale error from a lowest value embodiment to a highest value embodiment. For instance, an embodiment including a range from approximately 10 to approximately 100 with a ten percent full scale error may include values from 1 to 109.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Embodiments of a mount structure of a fiber optic closure are provided. Embodiments of the structure provided herein allow for universal and standardized placement, attachment, and securing of the fiber optic closure in an enclosed volume, such as an underground volume, confined space, or handhole. Embodiments provided herein may allow for articulation of the fiber optic closure within or out of the enclosed volume. Additionally, or alternatively, embodiments of the mount structure provided herein allow for the fiber optic closure to be placed at a height or location that facilitates operation at the fiber optic closure by a person. Embodiments provided herein may facilitate ergonomic placement, provide improved articulation and adjustment of the fiber optic closure, and allow for attachment of the mount structure to various types of fiber optic closures and mount interfaces.

Embodiments of the mount structure provided herein include a first bracket and may further include a second bracket separated along an axis from the first bracket. For instance, the first bracket may be a rearward bracket proximate to a rear opening of the fiber optic closure, and the second bracket may be a forward bracket proximate to a forward end of the fiber optic closure. The bracket(s) may be mounted onto and positioned on various types of rail assemblies forming any one or more cross-sectional areas. In some embodiments, the bracket(s) may be positioned on a conventional rail assembly, such as, but not limited to, a Cubis Systems™ Mobra Arm or a Hubbell IM swing arm.

Methods for mounting a fiber optic closure include attaching the first bracket to the rail assembly proximate to a pivot member of the rail assembly. A mount plate attaches to the fiber optic closure via one or more mechanical fasteners. The mount plate is coupled to the first bracket via an arm. The arm positions the plate and the fiber optic closure substantially parallel or co-directional to the rail, such as by forming the arm with one or more portions extended along a radial direction from the first bracket. In certain embodiments, the arm is separable from the first bracket to allow for rotation of the arm, plate, and the fiber optic closure together relative to the first bracket.

In various embodiments, a baseplate adapter is positioned between a mount interface at the fiber optic closure and the mount plate, such as to facilitate attaching the plate to a variety of fiber optic closure geometries. The mount plate includes curved channels or scallops along a perimeter of the mount plate to allow for entry or egress of fiber optic cables into and out of the fiber optic closure without impeding or blocking fiber optic cables to or from the closure. The mount plate may furthermore attach the fiber optic closure to the first bracket and rail assembly without blocking or repurposing any fiber optic cable entry ports, allowing for full usage of the fiber optic closure without losses imposed by the mount structure.

In some embodiments, the fiber optic closure may be cantilevered from the first bracket via the arm and the mount plate. In other embodiments, the mount structure further includes the second bracket attached to the rail assembly and attached to the fiber optic closure via a mechanical compression device or clamp. The mount structure may accordingly allow for forward and rearward support of the fiber optic closure. The mount structure may furthermore support the fiber optic closure while orienting the fiber optic closure substantially parallel to the rail, allowing for reduced volume usage within the enclosed volume. The second bracket may include adjustable clamping features such as may be included at the first bracket to allow for attachment to various cross-sectional areas of the rail assembly.

Embodiments of the mount structure allow for movement, translation, articulation, or rotation of the rail assembly, such as rotation from a horizontal position (e.g., approximately zero degrees or parallel to the ground) to a vertical position (e.g., approximately 90 degrees or perpendicular to the ground). Additionally, or alternatively, the separable arm from the first bracket may allow the mount structure to be articulated to the vertical position. The mount structure may further include a removable pin, bolt, camlock, clamp, mechanical stop, or other detent extendable through the rail and the first bracket. Removing the detent allows for the first bracket, separately from or together with the fiber optic closure, to be translated along the rail to position the fiber optic closure at a desired height. The detent may be re-insertable at various portions of the rail to fix the fiber optic closure at the desired height, allowing for a person to perform maintenance, assembly, disassembly, splicing, or other operations at the fiber optic closure from a desired height, such as may be more ergonomic for the operator. Additionally, or alternatively, the detent and translation of the first bracket may allow for the fiber optic closure to be stored within a relatively smaller enclosed volume and/or on a shorter rail assembly while allowing the fiber optic closure to be re-positioned or translated to a desired operating height.

Various embodiments of the first bracket, the arm, the plate, the adapter, and/or the second bracket depicted and described herein may be formed from any appropriate manufacturing process and/or any appropriate material. Exemplary materials include, but are not limited to, aluminum or aluminum alloy, steel or steel alloy, high-strength plastics, or combinations thereof. The mount structure, or portions thereof, may be formed by any one or more machining processes, forging or casting processes, molding or extrusions processes, additive manufacturing processes, or combinations thereof.

Embodiments of the mount structure depicted and described herein may allow for relatively larger fiber optic closures to be mounted into smaller enclosed volumes, which may allow for reduced volume of the enclosed volume. The mount structure may form a fully external attachment relative to the fiber optic closure. As such, embodiments of the mount structure provided herein may provide for fiber optic closure mounting without generating or increasing risks associated with compromising, degrading, or damaging fluid seals at the fiber optic closure. For instance, embodiments of the mount structure provided herein provide for mounting of the fiber optic closure via existing threads, sleeves, or fasteners at the fiber optic closure. Embodiments of the mount structure may furthermore provide for mounting and positioning without utilizing structures or components within the fiber optic closure or egresses common to, intended for, or otherwise utilizable by one or more fiber optic cables. Still further, embodiments of the mount structure may provide mounting while dissociating with splice capacity at the fiber optic closure, such as by avoiding utilization of ports, openings, or holes associated with one or more fiber optic cables.

Embodiments of the mount structure depicted and described herein including an adjustable clamping bracket may allow for quick adjustment to first different sized rails. Embodiments of the mount structure may be utilized with various rail dimensions or types, allowing for a single configuration to attach to various rail assembly geometries.

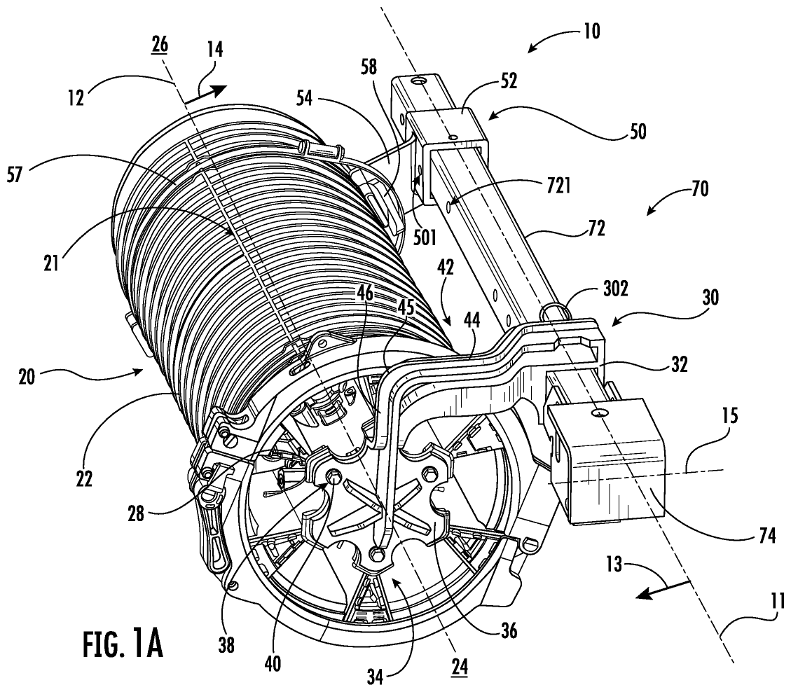

Referring now to FIG. 1A, a perspective view of an embodiment of a mount structure 10 for a fiber optic closure 20 is provided. A first axis 11 and a second axis 12 are extended substantially co-directional to one another. A first radial direction 13 is extended from the first axis 11 and a second radial direction 14 is extended from the second axis 12. A first end 24 and a second end 26 are defined and separated from one another relative to the first axis 11. In certain embodiments, the first end 24 is defined proximate to a third axis 15 extending perpendicular to the first axis 11, such as described further herein. The second end 26 is defined distal to the third axis 15. In certain embodiments, the first end 24 may refer to a bottom end of the fiber optic closure 20 and the second end 26 may refer to a top end of the fiber optic closure 20. The bottom end may particularly refer to an end or face of the fiber optic closure 20 through which one or more optical fibers or cables is extended into the housing 22, such as provided further herein. Accordingly, it should be appreciated that the optical fibers or cables may extend into the housing 22 through the top end, and orientations of the first end 24 and the second end 26 may be altered accordingly.

The housing 22 of the fiber optic closure 20 may form one or more ridges, ribs, or other raised walls 21 extended co-directional to the second axis 12 or circumferentially around the second axis 12 along an outer surface of the housing 22. The raised wall 21 may form a structural feature of the housing 22. Additionally, or alternatively, the raised wall 21 may form a locating feature, such as further described below:

Various embodiments of the mount structure 10 include a rail assembly 70. The rail assembly 70 includes a rail 72 extending along the first axis 11. The rail 72 may include one or more rail walls extending along the first axis 11 and forming a bar, cross-bar, cantilevered member, rod, pipe, or other appropriate structure at which a first bracket 30 desirably attaches and detaches. In a particular embodiment, the rail 72 is configured as a telescoping rail extendable and retractable along the first axis 11.

The rail assembly 70 may include a pivot member 74 at which the rail 72 is coupled. The pivot member 74 is configured to rotate the first axis 11 along the third axis 15 extended perpendicular to the first axis 11. The third axis 15 may particularly extend through the pivot member 74 of the rail assembly 70. In a particular embodiment, such as provided further herein, the pivot member 74 may be configured to rotate the first axis 11 by up to approximately 90 degrees.

The fiber optic closure 20 includes a housing 22 in which various appropriate devices for a fiber optic network may be enclosed. The housing 22 may be configured to enclose one or more optical fibers, at least a portion of one or more fiber optic cables, a signal splitter device (e.g., a multiplexer device, such as one or more configurations of wavelength division multiplexer), splices or splice trays, fiber optic testing devices, or internal mount hardware for one or more components within the housing 22. The housing 22 may be configured as any appropriate walled enclosure, pressure vessel, canister, or other appropriate body for housing components such as provided above. The housing 22 may particularly be extended along the second axis 12. In certain embodiments, the second axis 12 corresponds to a centerline axis of the housing 22. However, it should be appreciated that the housing 22 may be positioned off-center relative to the second axis 12 (e.g., along an axis separate along the second radial direction 14 from the second axis 12).

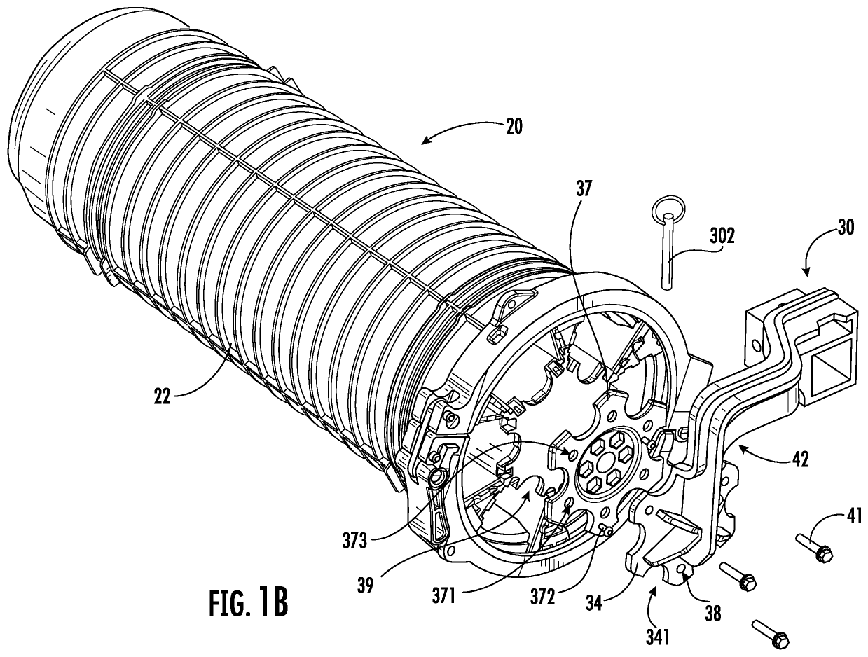

The mount structure 10 includes a first bracket 30 extending along the first axis 11. The first bracket 30 includes a plurality of first bracket walls 32 at least partially surrounding the first axis 11. The plurality of first bracket walls 32 forms a pathway 31 (FIG. 2) through which the first bracket 30 may be positioned around the walls of the rail 72. As provided herein, the rail 72 may form a substantially rectangular cross-sectional area. However, it should be appreciated that the rail 72 may form a circular cross-sectional area, or other appropriate cross-sectional area. The pathway 31 formed by the bracket walls 32 conforms substantially to the cross-sectional area of the rail 72.

A plate 34 including a plate wall 36 extending along the second radial direction 14 is extended from the second axis 12. A plate opening 38 extends along the second axis 12 through the plate wall 36. The plate opening 38 is configured to receive a fastener 40. The fastener 40 may include any appropriate type of mechanical fastener, such as, but not limited to, a bolt, screw, tie rod, and any appropriate nuts, sleeves, washers, bushings, collars, or other components as may be appropriate for fastening the fiber optic closure 20 to the plate 34 via the plate opening 38.

The mount structure 10 includes an arm 42 extending from the first bracket 30 to the plate 34. The arm 42 includes a first arm portion 44 extending along the first radial direction 13. The arm 42 includes a second arm portion 46 extending along the second radial direction 14. In a particular embodiment, the first arm portion 44 is extended from one or more of the plurality of first bracket walls 32. The second arm portion 46 is extended from the plate wall 36. In a still particular embodiment, the first arm portion 44 and the second arm portion 46 are extending toward one another and connected to form the arm 42.

In various embodiments, the first bracket 30 is attachable to, and detachable from, the rail 72. The first bracket 30 may be positioned along the first axis 11 proximate to first end 24. The first bracket 30 may support or hold the fiber optic closure 20 from the first end 24 or bottom end of the housing 22. In certain embodiments, the fiber optic closure 20 may suspended, or supported via the first bracket 30 cantilevering the housing 22 from the first end 24. In other embodiments, the mount structure 10 further includes a second bracket 50 attachable to, and detachable from, the rail 72 and separated from the first bracket 30 along the first axis 11. The second bracket 50 may particularly be separated along the first axis 11 from the first bracket 30 and proximate to the second end 26. A mechanical fastener or mechanical compression device, such as a clamp 57, is attached to the housing 22 and the second bracket 50, such as further described below.

During an embodiment of assembly, maintenance, installation, or other operation of the mount structure 10, the first bracket 30 is slid around the rail 72 from the second end 26 toward the first end 24. The fiber optic closure 20 is mounted or attached onto the plate 34 via one or more fasteners 40 extending through the plate opening 38 and into a corresponding interface at the fiber optic closure 20.

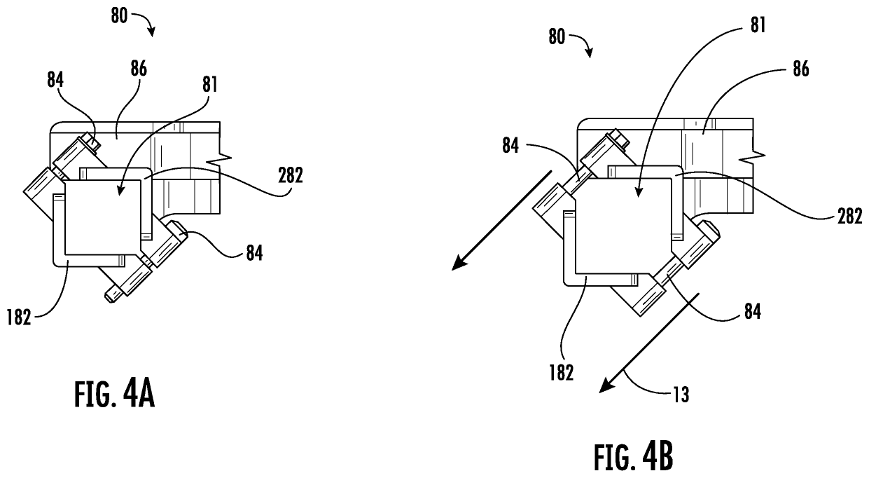

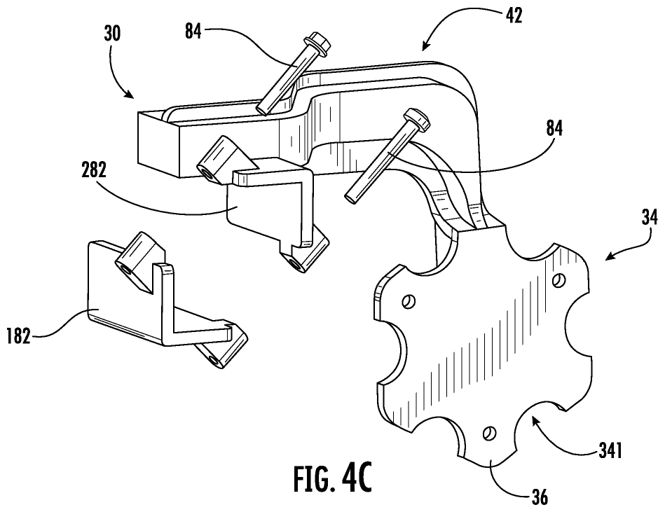

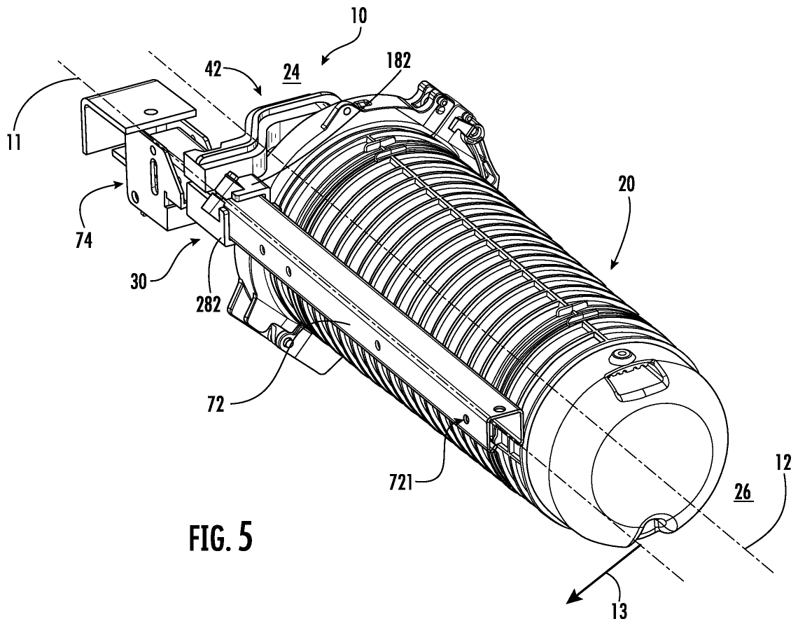

Referring to the embodiment depicted in FIG. 1A, and further with regard to embodiments depicted in FIG. 8, FIG. 9, and FIG. 10, the first bracket 30, the arm 42, and the plate 34 are formed as a single, unitary, monolithic, integral structure. The integral structure may be formed by any one or more appropriate manufacturing methods, including, but not limited to, casting, forging, extrusion, machining (e.g., machining from an integral, solid piece of material), or additive manufacturing process. The integral structure of the first bracket 30, the arm 42, and the plate 34 may facilitate installation of the mount structure 10 onto the rail assembly 70 and fiber optic closure 20, such as described herein.

Referring now to FIG. 1B, an exploded perspective view of an exemplary embodiment of the mount structure 10 for the fiber optic closure 20 is provided. The embodiment provided in FIG. 1B may be configured substantially similarly as depicted and described with regard to FIG. 1A. It should be appreciated that certain components depicted in FIG. 1A may be omitted for clarity in FIG. 1B. In FIG. 1B, a mount interface 28 of the housing 22 of the fiber optic closure 20 is depicted. The mount structure 10 includes a separable baseplate or adapter 37 configured to attach to the housing 22 of the fiber optic closure 20, or particularly at the mount interface 28. The adapter 37 forms a first adapter opening 371 configured to allow a first fastener 372 therethrough into the housing 22. The first fastener 372 may include any appropriate type of mechanical fastener, such as, but not limited to, screws, bolts, tie rods, or other threaded fastener. The first adapter opening 371 may form a counterbored hole, such as to allow a head of the first fastener 372 to rest flush with the adapter 37 and within a hole formed by the first adapter opening 371. The counterbored first adapter opening 371 may allow the plate 34, or particularly a plate wall 36 extended from the second axis 12 along the second radial direction 14, to couple flat or flush to the adapter 37 when the fastener 40 is provided through a second adapter opening 373 formed through the adapter 37.

The mount interface 28 includes a mount interface opening 281 extended through the mount interface 28. The mount interface opening 281 corresponds to the second adapter opening 373 through which the fastener 40 is provided. The plate 34 forms a plate opening 38 and allows for the fastener 40 to extend through the plate opening 38, the second adapter opening 373, and into the mount interface opening 281 to secure the plate 34 to the housing 22. In certain embodiments, the mount interface opening 281 is a discrete opening, such as a hole, or a threaded hole, or other retaining feature at the housing 22. In still certain embodiments, the mount interface opening 281 is an elongated slot allowing for the plate 34 to be desirably shifted to allow the fastener 40 to extend through the plate 34 and the mount interface 28.

In various embodiments, the adapter 37 is included between the mount interface 28 and the plate wall 36 with the second adapter opening 373 corresponding to the mount interface opening 281 and the plate opening 38, such as described above. The adapter 37 may particularly be configured to allow the plate 34 to fit, interface, or otherwise connect to the housing 22 at the mount interface 28. In various embodiments, the adapter 37 may be particular to the housing 22 to which the adapter 37 is attached. The plate 34 may be general to any number of embodiments of the adapter 37. During assembly, disassembly, maintenance, or other operation of the mount structure 10, the adapter 37 may be left on the fiber optic closure 20 whether the fiber optic closure 20 is mounted to the arm 42, first bracket 30, or rail assembly 70.

Referring now to FIG. 2A, an exploded perspective view of an exemplary embodiment of the mount structure 10 for the fiber optic closure 20 is provided. The embodiment provided in FIG. 2A may be configured substantially similarly as depicted and described with regard to FIGS. 1A-1B. It should be appreciated that certain components depicted in FIGS. 1A-1B may be omitted for clarity in FIG. 2A. Additionally, the embodiment depicted in FIG. 2 may configure the first bracket 30 and the arm 42 as an integral structure such as described above. The plate 34 may be separable from the arm 42, such as depicted in the exploded view in FIG. 2A. FIG. 2B provides a partially assembled view of the mount structure 10 such as provided in FIG. 2A. It should be appreciated that certain components depicted in FIG. 2A are omitted for clarity in FIG. 2B.

FIG. 2B depicts the plate 34 assembled to the fiber optic closure 20 such as described with regard to FIG. 1B. The first fastener 372 is extended through the plate 34, the adapter 37, and the mount interface 28 at the housing 22 (FIG. 2A). In a particular embodiment, threads of the first fastener 372 are extended into or otherwise retained at the adapter 37 and the mount interface 28, such as to allow the plate 34 to be removed and attached without necessitating removal of the first fastener 372.

FIG. 2C depicts a perspective view of the mount structure 10 for the fiber optic closure 20 such as may be configured substantially as depicted and described with regard to FIGS. 1A-1B or FIGS. 2A-2B. FIG. 2C further depicts the second bracket 50 slid over the rail 72 and aligned to a raised wall 21, such as a rib, formed at the housing 22. FIG. 2D depicts a perspective view of the mount structure 10 for the fiber optic closure 20 such as may be configured substantially as depicted and described with regard to FIGS. 1A-1B or FIGS. 2A-2C provided herein. FIG. 2D further depicts a mechanical compression device or clamp 57 attached to the second bracket 50. The clamp 57 exerts a compressive force to bind or support the housing 22 to the second bracket 50, such as further described herein.

Referring now to the embodiments depicted in FIGS. 1A-1B and FIGS. 2A-2D, various embodiments of the rail 72 include a rail opening 721 extended through one or more of the walls of the rail 72. In certain embodiments, such as depicted in FIG. 2, the first bracket 30 includes a first bracket opening 301 extended through one or more of the first bracket walls 32. The first bracket opening 301 corresponds to the rail opening 721 at the rail 72. The first bracket opening 301 allows a member, such as a key, bolt, pin, clamp, camlock, or other mechanical stop (hereinafter, “detent 302”) to extend through the first bracket opening 301 and the rail opening 721. When installed through the openings 721, 301, the detent 302 may prevent or otherwise disable movement, rotation, translation, or articulation of the first bracket 30 along the rail 72. When the fiber optic closure 20 is attached to the first bracket 30 such as described above, the fiber optic closure 20 is prevented from articulation along the first axis 11.

Referring to the embodiment depicted in FIG. 1A, certain embodiments of the second bracket 50 include a second bracket opening 501 extended through one or more of a second bracket wall 52 at least partially surrounding the first axis 11. The plurality of second bracket walls 52 may be configured to form a pathway 51 through which the second bracket 50 may be positioned around the walls of the rail 72, such as described with regard to the first bracket 30. The detent 302 may be installed through the openings 721, 501 to prevent or otherwise disable movement, rotation, translation, or articulation of the second bracket 50 along the rail 72. When the fiber optic closure 20 is attached to the second bracket 50 such as described herein, the fiber optic closure 20 is prevented from articulation along the first axis 11. The second bracket 50, with the detent 302 extended through the openings 721, 501, may further disable articulation of the first bracket 30 and fiber optic closure 20.

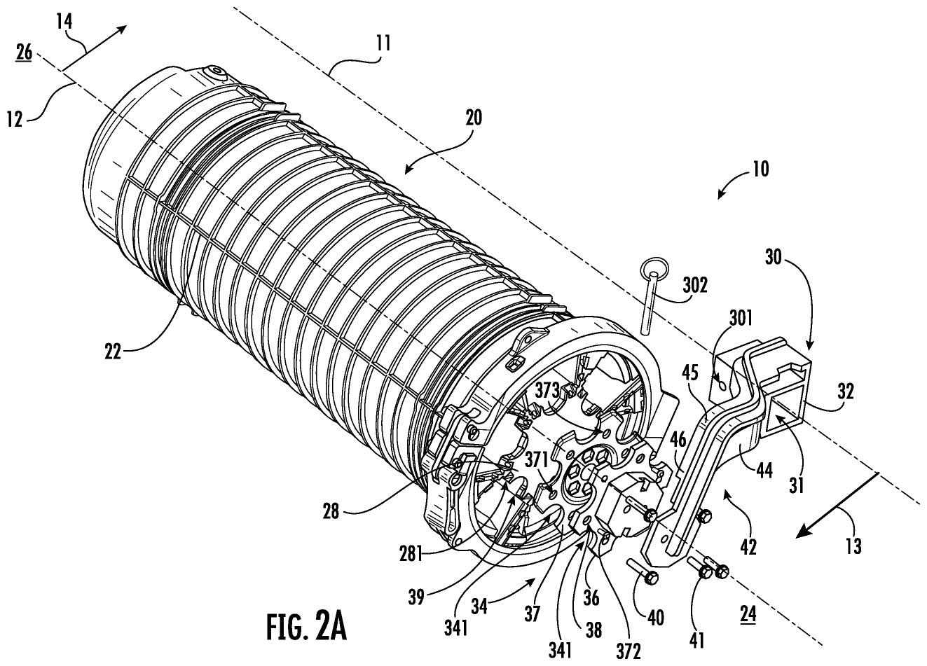

Referring now to FIG. 3A and FIG. 3B, an exemplary illustration of operation of the mount structure 10 is provided. Embodiments of the mount structure 10 may be configured substantially as depicted and described in one or more embodiments with regard to FIGS. 1A-1B or FIGS. 2A-2D. In a particular embodiment, the mount structure 10 is installed or mounted within an enclosed volume 60. An installed position of the fiber optic closure 20 is within the enclosed volume 60. The enclosed volume 60 may define a hole, a box, a manhole, a handhole, or other opening through a city street, sidewalk, or sewer system, or another underground volume generally, or a confined space generally. It should be appreciated that the confined space may be any volume having a limited opening for entry and exit, a space not intended for continuous human occupancy, and a space large enough for a human to enter and conduct work, such as work related to fiber optic maintenance, installation, assembly, or troubleshooting. Certain embodiments of the confined space may include one or more volumes substantially in accordance with definitions by the Occupational Safety and Health Administration or other regulatory or governing body. The enclosed volume 60 may form a volume at which the fiber optic closure 20 is contained, such as for, but not limited to, an underground or buried network, an aerial network, or other appropriate type of fiber optic network.

FIG. 3A depicts an initial operation at which the fiber optic closure 20 and rail 72 is rotated along the third axis 15 via rotation of the pivot member 74 to position the fiber optic closure 20 at partially out of the enclosed volume 60. The FIG. 3B depicts further articulation of the fiber optic closure 20 along the first axis 11, such as to position the fiber optic closure 20 completely out of the enclosed volume 60 or position the fiber optic closure 20 at a desired height to allow for more ergonomic positioning of the fiber optic closure 20. Articulation along the first axis 11 may include removing the second bracket 50 such as described above. Articulation may further include removing one or more detents 302, such as described above. Articulation may particularly include removing one or more detents 302 from the first openings 721, 301 proximate to the first end 24 and sliding the first bracket 30 along the rail 72 co-directional to the first axis 11. The detent 302 may be re-installed through the first bracket opening 301 and at another opening 721 more proximate to the second end 26. In another embodiment, the rail assembly 70 is a telescoping rail assembly that allows the rail 72 to articulate along the first axis 11 without removal and re-attachment of the detent 302.

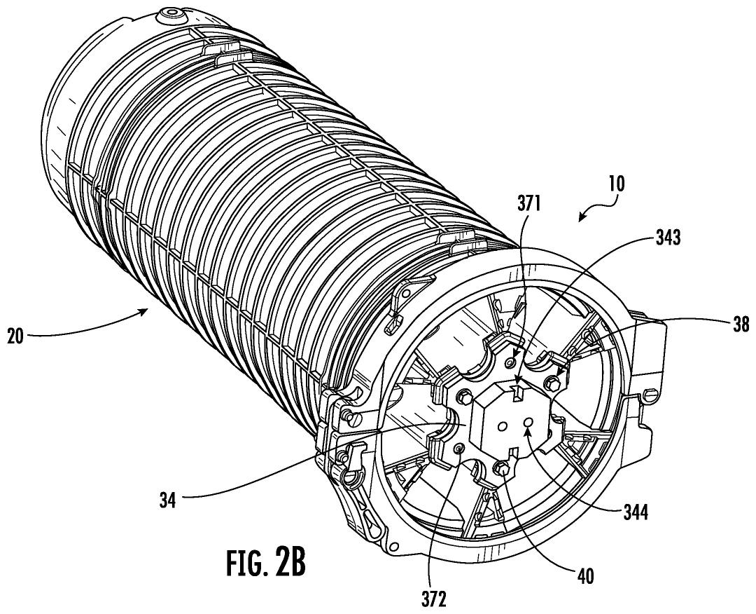

Referring now to FIG. 4A and FIG. 4B, an exemplary embodiment of an adjustable clamping bracket 80 is provided. The bracket 80 may be formed at the first bracket 30, the second bracket 50, or both. The bracket 80 includes bracket walls 82 forming a cross-sectional area 81, such as substantially conforming to the pathway 31, 51 depicted and described with regard to the first bracket 30 or second bracket 50. The bracket 80 includes a first bracket portion 182 separable from a second bracket portion 282. The bracket 80 includes an arm 86 that may correspond to the arm 42 attached to the first bracket 30 or an arm 54 attached to the second bracket 50. In one embodiment, the first bracket portion 182 may be attached, connected to, or integrally formed with the arm 42 at the first bracket 30. In another embodiment, the first bracket portion 182 may be attached, connected to, or integrally formed with the arm 54 at the second bracket 50. A fastener 84 is extended through openings at the first bracket portion 182 and the second bracket portion 282 to allow for the cross-sectional area 81 to increase or decrease. The first bracket wall 182 and/or the second bracket portion 282 may be separated from one another and the fastener 84. The fastener 84 may include any appropriate type of fastener, including, but not limited to, a threaded fastener, such as a screw or bolt and nut, a tie rod, or other appropriate fastener device.

Referring now to FIG. 4C, an exploded perspective view of an embodiment of the first bracket 30, the arm 42, and the plate 34 is provided. The embodiment of the first bracket 30 depicted in FIG. 4C is configured substantially similarly as depicted and described with regard to the clamping bracket 80 depicted and described with regard to FIG. 4A and FIG. 4B.

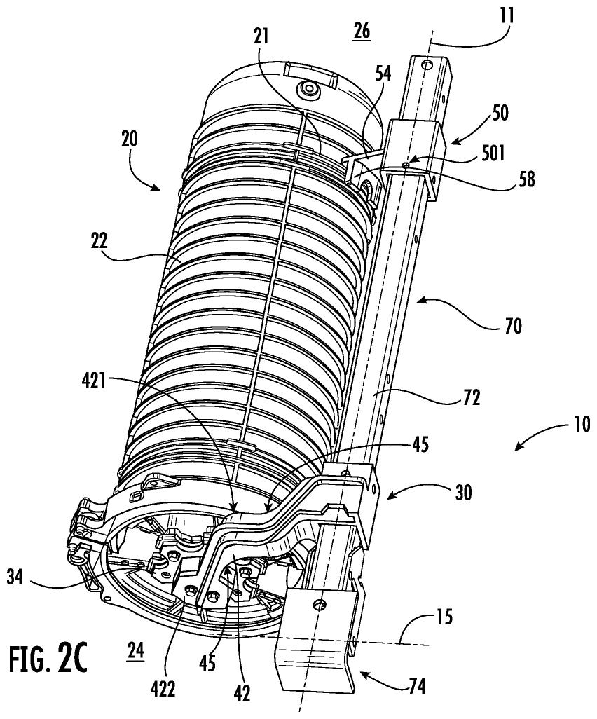

Referring now to FIG. 5, a perspective view of an embodiment of the fiber optic closure 20 and mount structure 10 is provided. The embodiment provided in regard to FIG. 5 may be configured substantially as depicted and described with regard to FIGS. 1A-1B, FIGS. 2A-2D, FIGS. 3A-3B, or FIGS. 4A-4C. When the adjustable clamping bracket 80 depicted in FIG. 4A, FIG. 4B, and FIG. 4C is formed at the first bracket 30, the second bracket 50 (not depicted), or both, the brackets 30, 50 may be installed onto the rail 72 without sliding the first bracket 30 along the rail 72 along the first axis 11. The second bracket portion 282 (FIG. 4A, FIG. 4B) may be attached and detached from the first bracket portion 182 along the first radial direction 13 and allowing the first bracket 30 and fiber optic closure 20 to be installed to the rail 72 or un-installed from the rail 72 along the first radial direction 13.

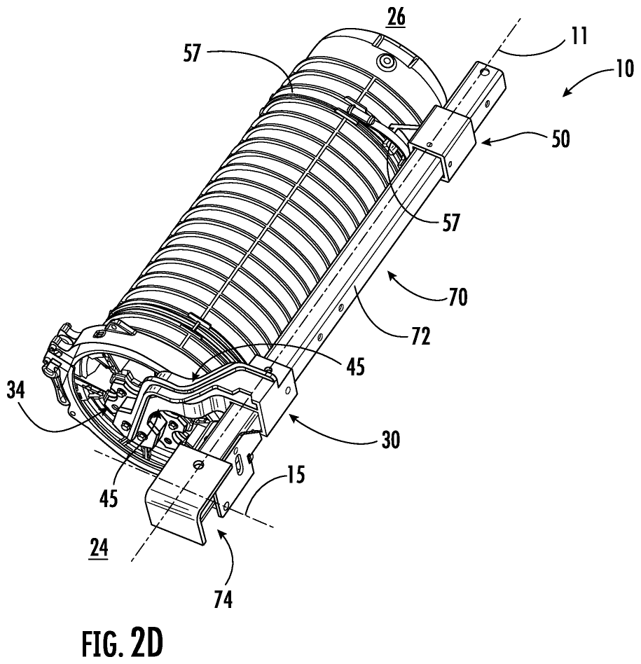

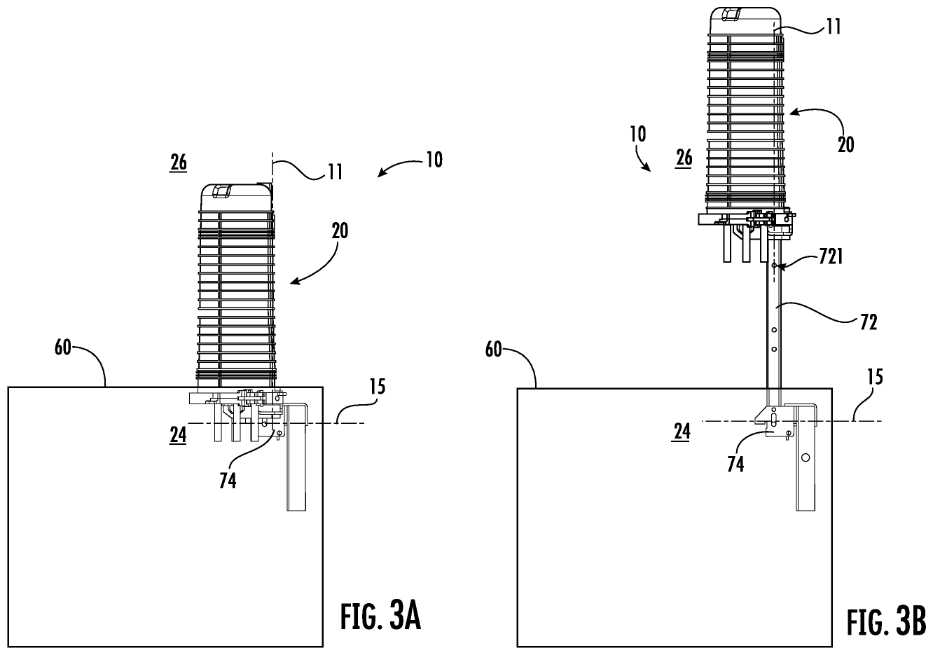

Referring now to FIG. 6, a perspective view of the second bracket 50 attached to the rail assembly 70 is provided. FIG. 7 is a view along the first axis 11 of an embodiment of the second bracket 50. The embodiments provided in FIG. 6 and FIG. 7 are configured substantially similarly as described with regard to FIGS. 1A-1B, FIGS. 2A-2D, FIGS. 3A-3B, FIGS. 4A-4C, or FIG. 5. In a particular embodiment, the arm 54 attached to the second bracket 50 is extended or oriented along the first radial direction 13 toward the second axis 12 (FIG. 1A). In certain embodiments, the second bracket 50 includes a notch 503 at the arm 54. The notch 503 is extended from a distal end of the arm 54 and is configured to correspond to a feature, such as the raised wall 21, at the fiber optic closure 20 (FIG. 1A). The notch 503 may form a slot or opening extended into the arm 54 along the first radial direction 13 toward the first axis 11. In a still particular embodiment, the notch 503 is extended, oriented, or pointed toward the second axis 12 (FIG. 1).

Referring still to FIG. 6 and FIG. 7, the second bracket 50 includes a platform 58 extended from the arm 54 co-directional to the first axis 11. The platform 58 provides a surface at which the clamp 57 (FIG. 1) may exert a compressive force to bind or support the housing 22 to the second bracket 50. In a particular embodiment, the clamp 57 is a hose clamp configured to extend circumferentially around the housing 22 and the platform 58. In another embodiment, the clamp 57 is a Marmon clamp. It should be appreciated that the clamp 57 may form any appropriate type of mechanical compressive device configured to bind or support the fiber optic closure 20 to the second bracket 50. The clamp 57 may form any appropriate type of mechanical compressive device configured to bind or support the housing 22 to the second bracket 50 at the platform 58.

Referring now to FIG. 8, a perspective view of an embodiment of a portion of the mount structure 10 is provided. FIG. 9 depicts a view of FIG. 8 along the first axis 11. FIG. 10 depicts a side view of FIG. 8 perpendicular to the view provided in FIG. 9. The embodiment provided with regard to FIGS. 8-10 is configured substantially similarly as any one or more embodiments depicted and described with regard to FIGS. 1-7. In a particular embodiment, the first bracket 30, the arm 42, and the plate 34 depicted in FIGS. 8-10 may be formed as a single, unitary, integral structure, such as described herein.

Referring to FIGS. 8-10, in various embodiments, the arm 42 includes one or more bends 45 forming an inflection or transition area at the arm 42. In one embodiment, the bend 45 is formed between the first arm portion 44 extending along the first radial direction 13 and the second arm portion 46 extending along the second radial direction 14. The bend 45 positions the first arm portion 44 and the second arm portion 46 at an angle 451 (FIG. 9) relative to one another. In various embodiments, the first arm portion 44 and the second arm portion 46 are extending at the angle 451 greater than 0 degrees and less than 180 degrees from one another. In one embodiment, the angle 451 is between approximately 20 degrees and approximately 160 degrees. In another embodiment, the angle 451 is between approximately 45 degrees and approximately 135 degrees. In still another embodiment, the angle 451 is between approximately 60 degrees and approximately 120 degrees. In still yet another embodiment, the angle 451 is approximately 90 degrees.

In another embodiment, such as depicted in FIGS. 1A-1B or FIGS. 2A-2D, the bend 45 forms a transition area at the arm 42 such as to place the first bracket 30 at a different position along the first axis 11 relative to the plate 34. For instance, the bend 45 may offset the first bracket 30 along a direction along the first axis 11 relative to the plate 34.

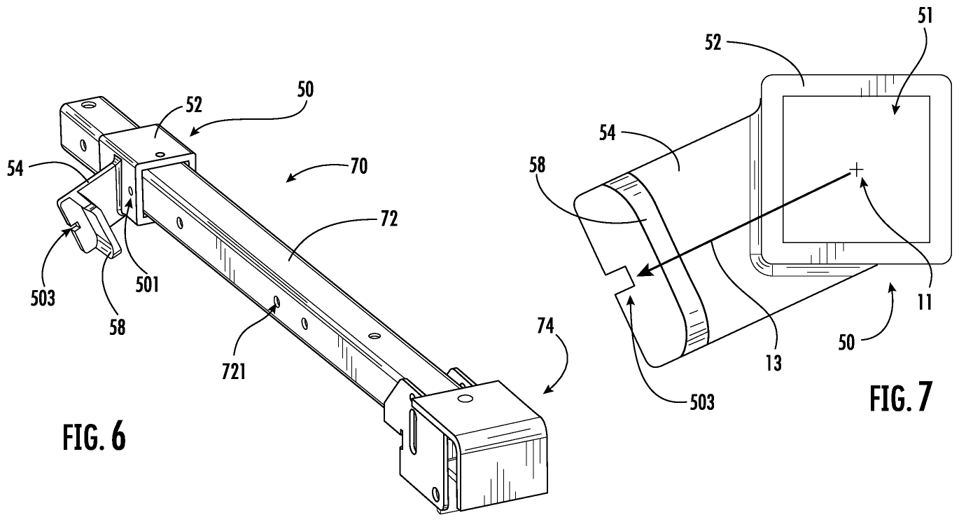

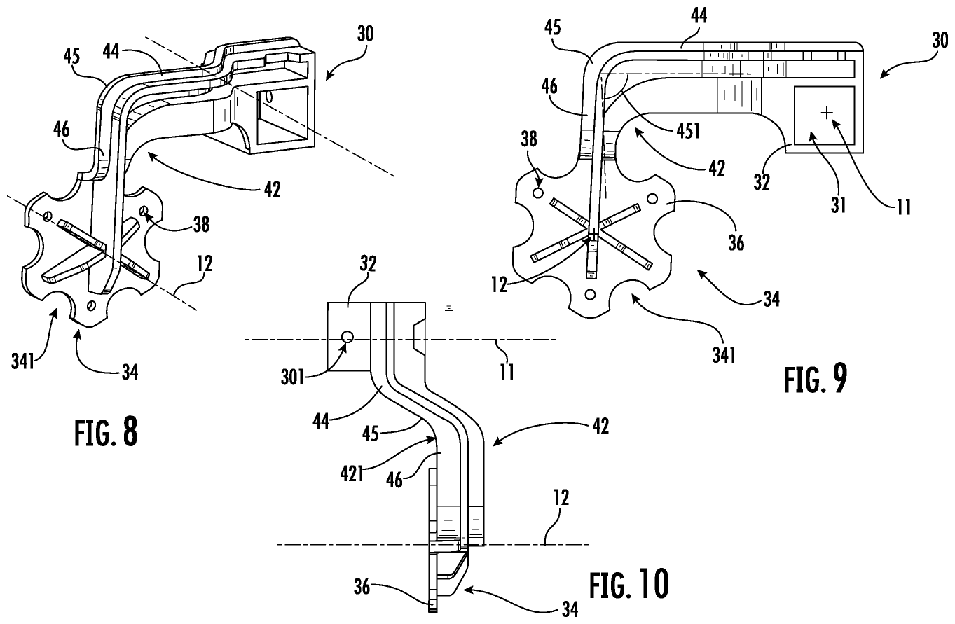

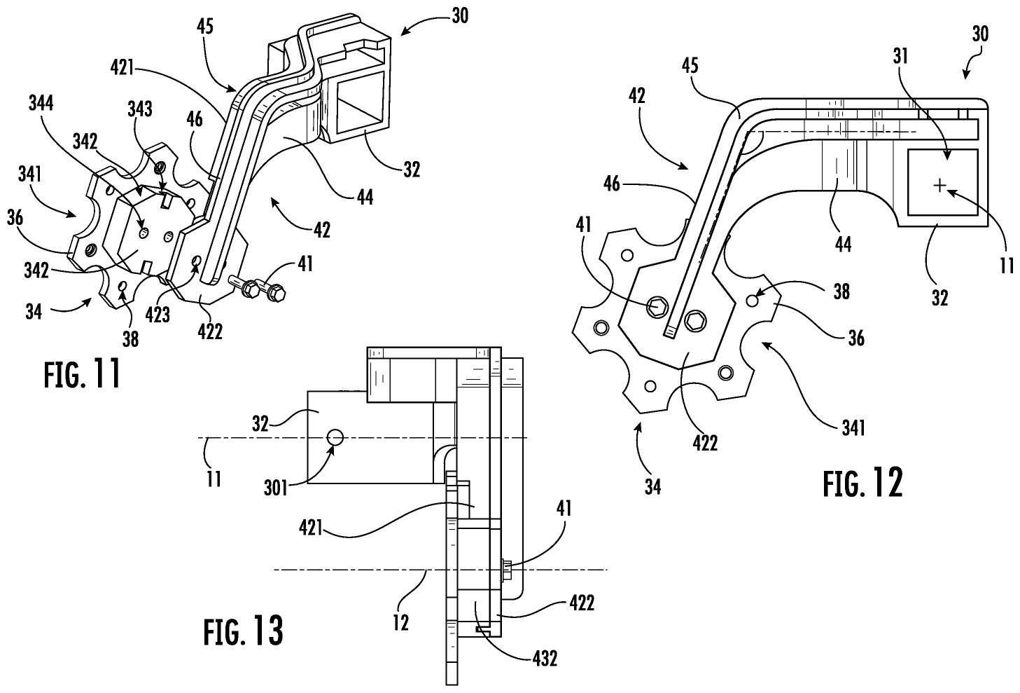

Referring now to FIG. 11, a perspective view of an embodiment of a portion of the mount structure 10 is provided. FIG. 12 depicts a view of FIG. 11 along the first axis 11. FIG. 13 depicts a side view of FIG. 11 perpendicular to the view provided in FIG. 12. The embodiment provided with regard to FIGS. 11-13 is configured substantially similarly as any one or more embodiments depicted and described with regard to FIGS. 1-0. In a particular embodiment, the first bracket 30 and the arm 42 depicted in FIGS. 11-13 may be formed as an integral structure, and the plate 34 is a separable structure from the arm 42 and/or the first bracket 30.

Referring to FIGS. 11-13, in certain embodiments, the arm 42 may form a rib 421 extending co-directional to the second axis 12. The rib 421 may provide structural support and integrity to the arm 42, such as to support, suspend, or cantilever the fiber optic closure 20 from the first bracket 30 when attached to the rail assembly 70. The plate 34 may form a platform 342 extending co-directional to the second axis 12. The platform 342 forms a notch 343 corresponding to the arm 42. In a particular embodiment, the notch 343 corresponds to the rib 421 formed at the arm 42. In a still particular embodiment, the notch 343 is configured to align the plate 34 relative to the arm 42. The notch 343 may accordingly allow for proper alignment of the plate 34 to the arm 42.

Referring still to FIGS. 11-13, the platform 342 forms a fastener opening 344 corresponding to a fastener opening 423 at an interface plate 422 formed at the arm 42. The fastener openings 344, 423 are configured to allow a fastener 41 to extend through and couple together the interface plate 422 at the arm 42 to the platform 342 at the plate 34.

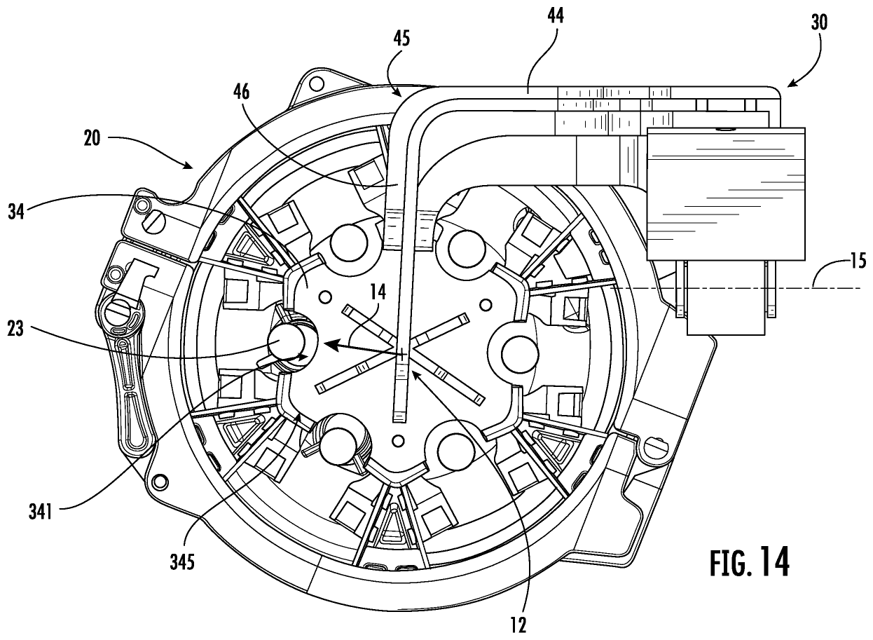

Referring now to FIG. 14, a view of an embodiment of the mount structure 10 and fiber optic closure 20 is provided along the second axis 12 is provided from the first end 24 viewing toward the second end 26. The embodiment depicted in FIG. 14 may be configured substantially similarly with regard to any one or more embodiments depicted and described with regard to FIGS. 1-13. Referring to FIG. 14, and further depicted with regard to FIGS. 8-13, the plate 34 forms one or more curved channels 341 along a perimeter 345 of the plate 34. The curved channel 341 extends inward along the second radial direction 14 to form scallops, semi-circles, recesses, or other geometries allowing for a fiber optic cable 23 to extend into the housing 22 without interference by the plate 34. The curved channels 341 allow for the fiber optic cables 23 to enter the fiber optic closure 20 without obstruction by the plate 34. The housing 22 may further form one or more curved channels 39 to which the curved channels 341 at the plate 34 correspond, such as depicted in FIG. 1B and FIG. 2A.

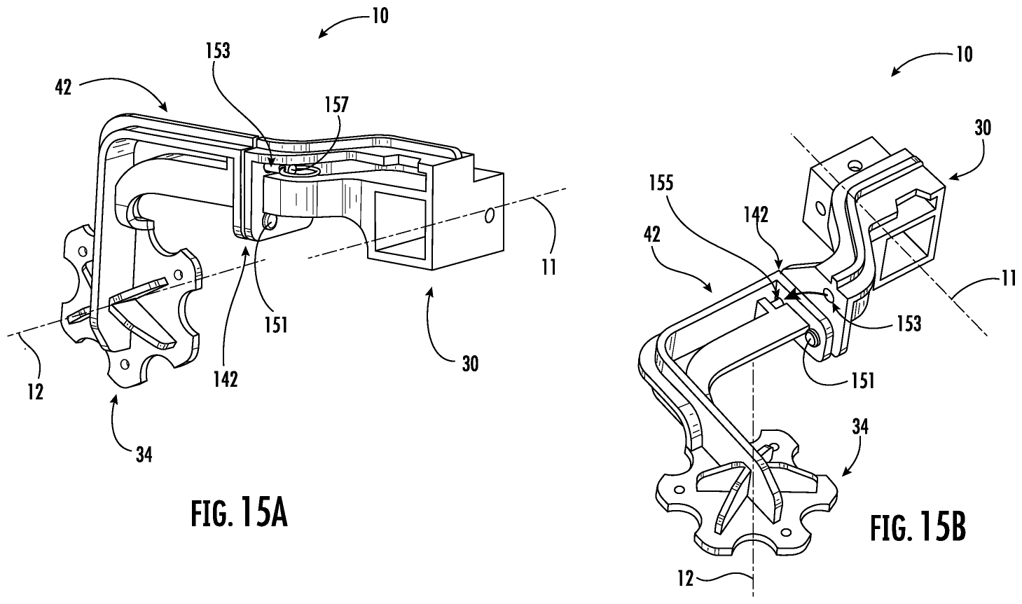

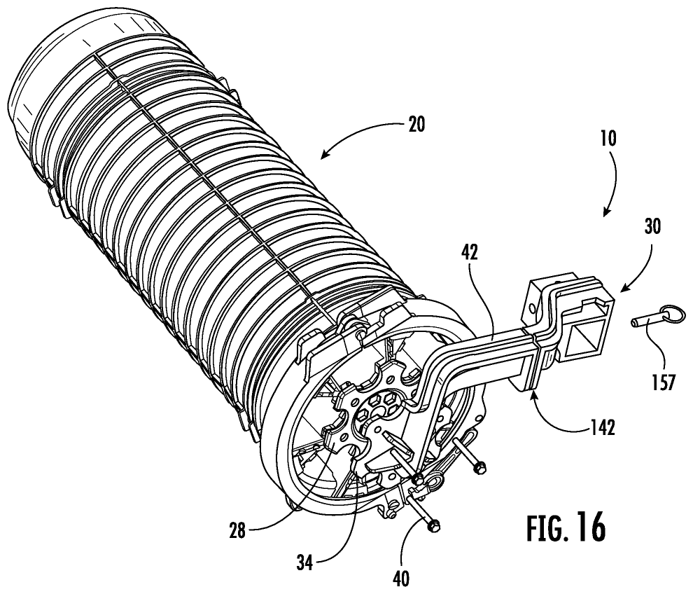

Referring now to FIG. 15A and FIG. 15B, an exemplary embodiment of a portion of the mount structure 10 is provided. FIG. 16 depicts a perspective view of at least a portion of the mount structure 10 and the fiber optic closure 20 such as depicted and described with regard to FIGS. 15A-15B. The embodiments depicted in FIGS. 15A-15B and FIG. 16 may be configured substantially similarly as described herein. It should be appreciated that elements or reference numbers may be omitted for clarity. The embodiments provided in FIGS. 15A-15B and FIG. 16 include the first bracket 30 separable from the arm 42. The first bracket 30 may be separable from the arm 42 at an interface 142 at which the first bracket 30 and the arm 42 are attachable to one another. In the embodiments provided in FIGS. 15A-15B, the arm 42 may be a unitary structure with the plate 34, such as described above. However, it should be appreciated that other embodiments may form the plate 34 as a separable structure from the arm 42, such as described elsewhere herein.

Referring to FIGS. 15A-15B, the embodiments include a first pathway 153 through which a pivot member 151 is extended into the first bracket 30 and the arm 42. One or more of a second pathway 155 is extended into the first bracket 30 and the arm 42 through which a pin or other detent 157 is extendable into the first bracket 30 and the arm 42. FIG. 15A depicts the mount structure 10 at a first position, such as the arm 42 and plate 34 positioning the second axis 12 substantially parallel to the first axis 11 set by the first bracket 30. The detent 157 is positioned through the first pathway 153 to fix the arm 42 relative to the first bracket 30. When the fiber optic closure 20 is attached to the plate 34 with the detent 157 extended through the arm 42 and the first bracket 30 at the first pathway 153, the fiber optic closure 20 is extended substantially co-directional with the first axis 11. When the detent 157 is removed from the first pathway 153, the arm 42 and plate 34 may be rotated via the pivot member 151 and the detent 157 may be re-installed into the second pathway 155. FIG. 15B depicts the mount structure 10 at a second position, such as the arm 42 and plate 34 positioning the second axis 12 oblique or perpendicular to the first axis 11 via rotating the plate 34 and arm 42 via the pivot member 151. When the fiber optic closure 20 is attached to the plate 34 with the detent 157 extended through the arm 42 and the first bracket 30 at the second pathway 155, the fiber optic closure 20 is extended oblique or perpendicular with the first axis 11.

In certain embodiments, the second pathway 155 is formed approximately 90 degrees from the first pathway 153. In still various embodiments, one or more of the second pathway 155 are formed greater than zero degrees from the first pathway 153 and up to 90 degrees from the first pathway 153. The first pathway 153 and the second pathway 155 may accordingly allow for the fiber optic closure 20 and second axis 12 to be positioned at one or more corresponding angles relative to the first axis 11. In still various embodiments, the first pathway 153 and the second pathway 155 are each extending through the first bracket 30 and the arm 42 across the interface 142. The pivot member 151 and the detent 157 may each be extended through the first bracket 30 and the arm 42 through the interface 142.

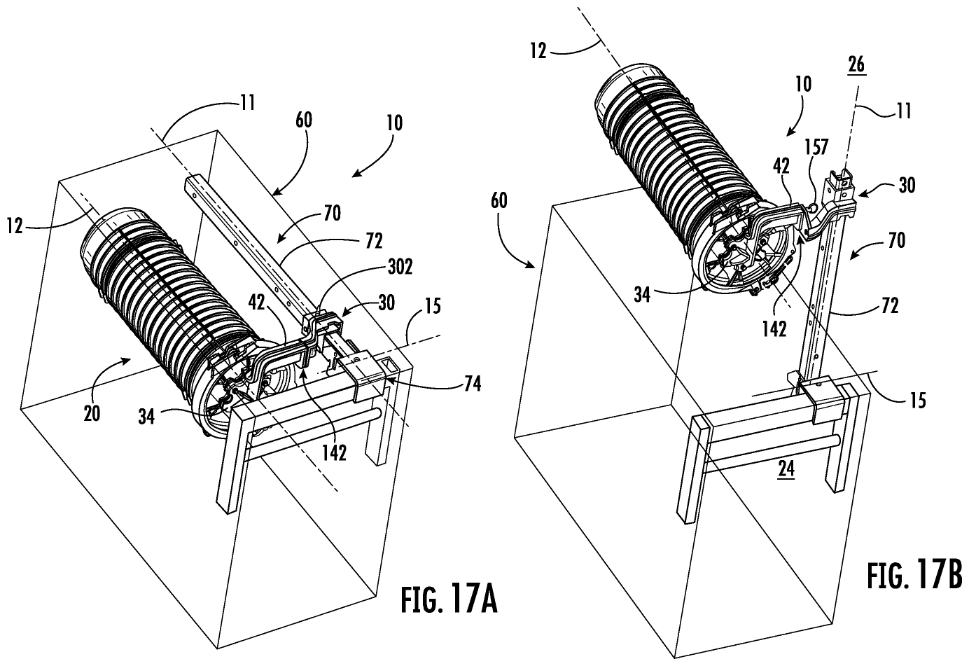

Referring now to FIGS. 17A-17B, perspective views of operation of embodiments of the mount structure 10 for the fiber optic closure 20 are provided. FIG. 17A depicts the fiber optic closure 20 within the enclosed volume 60. Embodiments of the mount structure 10 provided herein allow for the fiber optic closure 20 to be positioned substantially parallel to the first axis 11 and rail 72 within the enclosed volume 60. Operation of the mount structure 10 may include rotating the rail 72 via the pivot member 74 to position the rail 72 and first axis 11 substantially perpendicular or oblique relative to the second axis 12, such as depicted in FIG. 17B. Rotating the rail 72 may position the fiber optic closure 20 such as depicted in FIG. 3A. Operation of the mount structure 10 may further include removing the detent 302 from the first bracket 30 and the rail 72 to slide the fiber optic closure 20 and first bracket 30 toward the second end 26, such as depicted and described with regard to FIG. 3B. Operation of the mount structure 10 may further include fixing the first bracket 30 to the rail 72, such as via the detent 302, after sliding the fiber optic closure 20 toward the second end 26. Operation of the mount structure 10 may include rotating the fiber optic closure 20 via removing the detent 157 from the arm 42 and rotating the arm 42 such as depicted and described with regard to FIGS. 15A-15B. Rotating the arm 42 may position the fiber optic closure 20 substantially perpendicular or oblique to the first axis 11, such as depicted in FIG. 17B. Rotating the arm 42 may further allow the fiber optic closure 20 to be positioned out of the enclosed volume 60 while being positioned substantially perpendicular or oblique to the first axis 11. The fiber optic closure 20 may accordingly be positioned substantially horizontal or parallel to the ground. Such a position may facilitate access to the rear end (e.g., the fiber optic cables extending into the housing 22).

Embodiments of the mount structure 10 provided herein allow for movement, translation, articulation, or rotation of the rail assembly 70, such as rotation from a horizontal position (e.g., approximately zero degrees or parallel to the ground) to a vertical position (e.g., approximately 90 degrees or perpendicular to the ground). Additionally, or alternatively, the separable arm 42 from the first bracket 30 may allow the mount structure 10 to be articulated to the vertical position. The mount structure 10 may further include a removable pin, bolt, camlock, clamp, mechanical stop, or other detent 302 extendable through the rail 72 and the first bracket 30. Removing the detent 302 allows for the first bracket 30, separately from or together with the fiber optic closure 20, to be translated along the rail 72 to position the fiber optic closure 20 at a desired height. The detent 302 may be re-insertable at various portions of the rail 72 to fix the fiber optic closure 20 at the desired height, allowing for an operator to perform maintenance, assembly, disassembly, splicing, or other operations at the fiber optic closure 20 from a desired height, such as may be more ergonomic for the operator. Additionally, or alternatively, the detent 302 and translation of the first bracket 30 may allow for the fiber optic closure 20 to be stored within a relatively smaller enclosed volume 60 and/or on a shorter rail assembly 70 while allowing the fiber optic closure 20 to be re-positioned or translated to a desired operating height.

Embodiments of the mount structure 10 depicted and described herein may allow for relatively larger fiber optic closures 20 to be mounted into smaller enclosed volumes 60, which may allow for reduced volume of the enclosed volume. The mount structure 10 may form a fully external attachment relative to the fiber optic closure 20. As such, embodiments of the mount structure 10 provided herein may provide for fiber optic closure 20 mounting without generating or increasing risks associated with compromising, degrading, or damaging fluid seals at the fiber optic closure 20. For instance, embodiments of the mount structure 10 provided herein provide for mounting of the fiber optic closure 20 via existing threads, sleeves, or fasteners at the fiber optic closure 20 (e.g., the mount interface opening 281). Embodiments of the mount structure 10 may furthermore provide for mounting and positioning without utilizing structures or components within the fiber optic closure 20 or egresses common to, intended for, or otherwise utilizable by one or more fiber optic cables 23. Still further, embodiments of the mount structure 10 may provide mounting while dissociating with splice capacity at the fiber optic closure 20, such as by avoiding utilization of ports, openings, or holes associated with one or more fiber optic cables.

Embodiments of the mount structure 10 depicted and described herein including an adjustable clamping bracket 80 may allow for quick adjustment to first different sized cross sectional areas of the rail 72. Embodiments of the mount structure 10 may be utilized with various rail dimensions or types, allowing for a single configuration to attach to various geometries of rail assembly 70.

Further aspects of the invention are provided by one or more of the following embodiments:

1. A mount structure for a fiber optic closure, the mount structure including a first bracket extending along a first axis, wherein the first bracket includes a plurality of first bracket walls at least partially surrounding the first axis: a plate including a plate wall extending along a second radial direction extending from a second axis, wherein a plate opening extends along the second axis through the plate wall; and an arm extending from the first bracket to the plate, wherein the arm includes a first arm portion extending along a first radial direction from the first axis, and wherein the arm includes a second arm portion extending along the second radial direction.

2. The mount structure of any one or more clauses herein, wherein the first arm portion is extended from one or more of the plurality of first bracket walls, and wherein the second arm portion is extended from the plate wall, and wherein the first arm portion and the second arm portion are connected to one another.

3. The mount structure of any one or more clauses herein, wherein a perimeter of the plate forms a curved channel extended inward along the second radial direction.

4. The mount structure of any one or more clauses herein, wherein the first bracket, the plate, and the arm are a unitary, integral structure.

5. The mount structure of any one or more clauses herein, wherein the first bracket is separable from the plate.

6. The mount structure of any one or more clauses herein, wherein the first bracket and the arm are separable at an interface, and wherein a first pathway extends into the first bracket and the arm, and wherein a pivot member extends through the first pathway into the first bracket and the arm.

7. The mount structure of any one or more clauses herein, wherein a second pathway is extended into the first bracket and the arm, and wherein the second pathway extends into the first bracket and the arm, and wherein a detent is extendable through the second pathway into the first bracket and the arm.

8. The mount structure of any one or more clauses herein, wherein the second pathway is formed greater than zero degrees and up to 90 degrees from the first pathway.

9. The mount structure of any one or more clauses herein, wherein the plate is separable from the arm.

10. The mount structure of any one or more clauses herein, the plate including a platform extending co-directional to the second axis, wherein the platform forms a fastener opening, and wherein the fastener opening is configured to allow a fastener to extend through the fastener opening and the arm, and wherein the plate wall is coupled to the platform.

11. The mount structure of any one or more clauses herein, wherein the platform forms a notch corresponding to the arm, wherein the notch is configured to align the plate wall relative to the arm.

12. The mount structure of any one or more clauses herein, wherein the plurality of first bracket walls forms a cross sectional area extended from the first axis, and wherein the plurality of first bracket walls forms an adjustable clamping bracket configured to change the cross sectional area.

13. The mount structure of any one or more clauses herein, wherein the adjustable clamping bracket includes a first bracket portion and a second bracket portion together surrounding the first axis, and wherein a fastener opening is extended through the first portion and the second portion, and wherein a fastener is extendable through the fastener opening through the first portion and the second portion.

14. The mount structure of any one or more clauses herein, the mount structure including a second bracket extending along the first axis, wherein the second bracket includes a plurality of second bracket walls at least partially surrounding the first axis, and wherein a second bracket arm extends from the second bracket walls.

15. The mount structure of any one or more clauses herein, wherein a platform extends co-directional to the first axis from the second bracket arm.

16. The mount structure of any one or more clauses herein, wherein a mechanical compression device is extendable to the platform to exert a compressive force to the second bracket and the fiber optic closure.

17. The mount structure of any one or more clauses herein, the mount structure including a rail assembly including a rail and a pivot member, wherein the first bracket is attachable to the rail, and wherein the rail forms a rail opening, wherein a detent is extendable through the rail opening and a fastener opening at the first bracket.

18. The mount structure of any one or more clauses herein, the mount structure including an adapter forming a first adapter opening, wherein the first adapter opening is configured to allow a first fastener through the adapter into the fiber optic closure.

19. The mount structure of any one or more clauses herein, wherein the first adapter opening forms a counterbored hole.

20. The mount structure of any one or more clauses herein, wherein the adapter forms a second adapter opening, wherein a second fastener is extendable through the plate opening and the second adapter opening.

21. The mount structure of any one or more clauses herein, wherein the first arm portion and the second arm portion are extending at an angle greater than 0 degrees and less than 180 degrees from one another.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A mount structure for a fiber optic closure, the mount structure comprising:
a first bracket extending along a first axis, wherein the first bracket comprises a plurality of first bracket walls at least partially surrounding the first axis;
a plate comprising a plate wall extending along a second radial direction extending from a second axis, wherein a plate opening extends along the second axis through the plate wall; and
an arm extending from the first bracket to the plate, wherein the arm comprises a first arm portion extending along a first radial direction from the first axis, and wherein the arm comprises a second arm portion extending along the second radial direction.

2. The mount structure of claim 1, wherein the first arm portion is extended from one or more of the plurality of first bracket walls, and wherein the second arm portion is extended from the plate wall, and wherein the first arm portion and the second arm portion are connected to one another.

3. The mount structure of claim 1, wherein a perimeter of the plate forms a curved channel extended inward along the second radial direction.

4. The mount structure of claim 1, wherein the first bracket, the plate, and the arm are a unitary, integral structure.

5. The mount structure of claim 1, wherein the first bracket is separable from the plate.

6. The mount structure of claim 5, wherein the first bracket and the arm are separable at an interface, and wherein a first pathway extends into the first bracket and the arm, and wherein a pivot member extends through the first pathway into the first bracket and the arm.

7. The mount structure of claim 6, wherein a second pathway is extended into the first bracket and the arm, and wherein the second pathway extends into the first bracket and the arm, and wherein a detent is extendable through the second pathway into the first bracket and the arm.

8. The mount structure of claim 7, wherein the second pathway is formed greater than zero degrees and up to 90 degrees from the first pathway.

9. The mount structure of claim 1, wherein the plate is separable from the arm.

10. The mount structure of claim 9, the plate comprising:
a platform extending co-directional to the second axis, wherein the platform forms a fastener opening, and wherein the fastener opening is configured to allow a fastener to extend through the fastener opening and the arm, and wherein the plate wall is coupled to the platform.

11. The mount structure of claim 10, wherein the platform forms a notch corresponding to the arm, wherein the notch is configured to align the plate wall relative to the arm.

12. The mount structure of claim 1, wherein the plurality of first bracket walls forms a cross sectional area extended from the first axis, and wherein the plurality of first bracket walls forms an adjustable clamping bracket configured to change the cross sectional area.

13. The mount structure of claim 12, wherein the adjustable clamping bracket comprises a first bracket portion and a second bracket portion together surrounding the first axis, and wherein a fastener opening is extended through the first portion and the second portion, and wherein a fastener is extendable through the fastener opening through the first portion and the second portion.

14. The mount structure of claim 1, the mount structure comprising:
a second bracket extending along the first axis, wherein the second bracket comprises a plurality of second bracket walls at least partially surrounding the first axis, and wherein a second bracket arm extends from the second bracket walls.

15. The mount structure of claim 14, wherein a platform extends co-directional to the first axis from the second bracket arm.

16. The mount structure of claim 15, wherein a mechanical compression device is extendable to the platform to exert a compressive force to the second bracket and the fiber optic closure.

17. The mount structure of claim 1, the mount structure comprising:
a rail assembly comprising a rail and a pivot member, wherein the first bracket is attachable to the rail, and wherein the rail forms a rail opening, wherein a detent is extendable through the rail opening and a fastener opening at the first bracket.

18. The mount structure of claim 1, the mount structure comprising:
an adapter forming a first adapter opening, wherein the first adapter opening is configured to allow a first fastener through the adapter into the fiber optic closure.

19. The mount structure of claim 18, wherein the first adapter opening forms a counterbored hole.

20. The mount structure of claim 19, wherein the adapter forms a second adapter opening, wherein a second fastener is extendable through the plate opening and the second adapter opening.
